(19) United States
(12) Patent Application Publication
(10) Pub. No.: US 2006/0137979 A1
(43) Pub. Date: Jun. 29, 2006

(54) Sensor element for determining gas components in gas mixtures and method for manufacturing the same

(76) Inventors: Walter Strassner, Schorndorf (DE); Lothar Diehl, Gerlingen (DE); Juergen Schwarz, Rutesheim (DE); Marcus Scheffel, Gerlingen (DE)

Correspondence Address: KENYON & KENYON LLP, ONE BROADWAY, NEW YORK, NY, 10004, US

(21) Appl. No.: 11/288,852

(22) Filed: Nov. 28, 2005

(30) Foreign Application Priority Data
Nov. 30, 2004 (DE) 10 2004 057 687.4
Nov. 28, 2005 (DE) 10 2005 056 522.0

(51) Int. Cl. G01N 27/26

(52) U.S. Cl. 204/424; 204/431

(57) ABSTRACT

A sensor element for determining gas components in gas mixtures and a method for manufacturing the sensor element are provided, the sensor element having at least one pump cell which includes a first electrode and a second electrode, the first electrode being situated in a measuring gas space of the sensor element, and the pump cell pumping oxygen into or out of the measuring gas space of the sensor element. The surface area of the second electrode is greater than that of the first electrode, and the second electrode has a diffusion barrier against the gas mixture diffusing to the second electrode, the diffusion resistance of the diffusion barrier being determined by its porosity and/or layer thickness being selected such that, given a predefined pump voltage applied to the first and second electrodes, essentially the same pump current flows between the electrodes as would flow if the diffusion barrier were not provided and both electrodes had the same surface areas exposed to the gas mixture.

### FIELD OF THE INVENTION

The present invention relates to a sensor element for determining gas components in gas mixtures, and particularly relates to a sensor element for determining the oxygen concentration in exhaust gases of internal combustion engines and a method for manufacturing the sensor element.

### BACKGROUND INFORMATION

Sensor elements for determining the oxygen concentration in exhaust gases of internal combustion engines are known in the art. Such oxygen sensor elements are generally formed from a planar solid electrolyte body and have an electrochemical pump cell and an electrochemical Nernst cell or concentration cell cooperating with it. Such oxygen sensor elements are also referred to as broadband lambda sensors.

Oxygen is pumped from a measuring gas space of the sensor into the exhaust gas stream or from the exhaust gas stream into the measuring gas space with the aid of the pump cell electrodes. For this purpose, one of the pump electrodes is mounted in the measuring gas space and the other one on an external surface, exposed to the exhaust gas stream, of the sensor element. One of the electrodes of the concentration cell is also situated in the measuring gas space, while the other one is situated in a reference gas channel normally filled with air. This arrangement allows the oxygen potential of the measuring electrode in the measuring gas space to be directly compared to the reference oxygen potential of the reference electrode in the form of a measurable voltage applied to the concentration cell. For measuring, the pump voltage applied to the electrodes of the pump cell is selected in such a way that a predefined voltage value is maintained across the concentration cell. The pump current flowing between the electrodes of the pump cell is used as a measuring signal of the sensor element, proportional to the oxygen concentration.

This control has the effect that, at lambda values <1 in the gas mixture, oxygen is transported from the external pump electrode situated on a major surface area of the sensor element to the internal pump electrode provided in a measuring gas space within the sensor element, and for lambda values >1, oxygen is transported from the internal to the external pump electrode. A polarity reversal of the pump electrodes and a brief charge shift within the ion-conductive solid electrolyte material thus take place at lambda=1, inducing a voltage across the concentration cell which controls the pump cell. In addition to the polarity reversal of the externally applied pump voltage, an electrochemical potential, i.e., a Nernst voltage, builds up between external and internal pump electrodes at the time of transition from lambda values >1 to lambda values <1, which disappears again at the time of transition from lambda values <1 to lambda values >1. These processes result in a brief disturbance of the control of the electrochemical pump cell and thus in a counter-swing or overshoot phenomenon of the measuring signal of the sensor element when the composition of the gas mixture changes abruptly. This is referred to as lambda=1 ripple.

A solution to eliminate this problem is described in published German patent document DE 198 05 023, for example, which provides a two-layer design of the protective layer which shields the external pump electrode against the gas mixture to be determined, the resulting protective layer having a greater thickness and thus a greater diffusion resistance to gas penetration. In this way, polarity reversal occurs more slowly at the external pump electrode, and dampening of the lambda=1 ripple is observed. The use of a thicker protective layer, however, results in an increased pump voltage requirement, which in continuous use of the sensor element may further increase and thus overload the trigger electronics of the sensor element.

Furthermore, it is described in published German patent document DE 101 51 328 that the problem of the lambda=1 ripple may be eliminated by substantially reducing the surface area of the external pump electrode in comparison with that of the internal pump electrode, thus reducing the number of charge carriers in the area of the external pump electrode. However, a smaller surface area of the external pump electrode is undesirable, because the effects of local corrosion phenomena at this electrode consequently affect the measuring performance to a higher degree and result in a higher pump voltage requirement.

An object of the present invention is to provide a sensor element which exhibits essentially no lambda=1 ripple in the event of dynamic changes in the composition of a gas mixture and yet avoids the shortcomings of the related art.

### SUMMARY OF THE INVENTION

The sensor element and the method according to the present invention have the advantage over the related art in that the gas components in a gas mixture are able to be determined even in the event of a changing composition of the gas mixture, while avoiding the occurrence of signal overshoot (i.e., lambda=1 ripple). At the same time, accurate measuring signals are obtained and high corrosion resistance of the sensor element is achieved. The surface area of an external pump electrode of the sensor element is greater than that of an internal pump electrode, and the external pump electrode is shielded by a diffusion barrier against a gas mixture diffusing to the external pump electrode, the diffusion resistance of the diffusion barrier being selected such that a predefined pump voltage applied to the external and internal pump electrodes results in essentially the same pump current flowing between the pump electrodes as would flow if both pump electrodes had the same major surface areas exposed to the gas mixture.

It is advantageous if the major surface area of the external pump electrode exposed to the gas mixture is 1.5 to 6 times greater than that of the internal pump electrode.

It is furthermore advantageous if the diffusion barrier is designed as a porous ceramic zirconium dioxide layer, because in this way the diffusion barrier may be implemented in a cost-effective way and exhibits long-term stability, while providing a contribution to the ion-conductive bond between the external pump electrode and the surrounding solid electrolyte material.

In an example embodiment, the major surface area of the external pump electrode exposed to the gas mixture may have an area of 6 mm² to 10 mm².

In an advantageous example embodiment of the present invention, the sensor element includes a measuring gas-side end and a support-side end, the major surface area of the external pump electrode exposed to the gas mixture increasing toward the measuring gas-side end of the sensor element. In this way, the greatest possible distance is implemented in ordinary sensor elements between the area of gravity of the external pump electrode and the area of gravity of a reference electrode integrated into the sensor element.

A cavity is situated on the external pump electrode of the sensor element. The cavity is situated on the side of the external pump element which faces away from the internal pump electrode. Providing the cavity makes it possible that the gas exchange occurs even more slowly on the external pump electrode. The cavity forms an additional reservoir, which further slows down the exchange. Signal overshoot (lambda=1 ripple) is thereby further reduced. In particular, in combination with the enlarged surface of the external pump electrode, the response of the pump cell to dynamic pressure changes is reduced. The enlarged external pump electrode thus filters the dynamic dependence on pressure. The dynamics of the sensor may thus become lambda-independent. Furthermore, a pump voltage requirement over the total service life of the sensor element remains small, which extends the total service life of the sensor element in particular.

The cavity may be filled with a porous material, which has a higher porosity than a porosity of the diffusion barrier. The cavity may thus alternatively be completely hollow or filled partly or fully with a highly porous material.

To further advantage, the cavity is formed over the entire surface of the external pump electrode.

The cavity over the external pump electrode may have a thickness between 5 μm and 50 μm, in particular 15 μm.

The diffusion barrier situated over the cavity may have a thickness such that, at an oxygen partial pressure of 0.5 mbar, a maximum current between 20 μA and 45 μA flows between the external and internal pump electrodes.

The diffusion barrier may include a gas-tight layer. This lengthens the diffusion path and allows access of gas to the external pump electrode only in the lateral areas. The gas-tight layer may be produced from ZrO₂ or Al₂O₃.

An insulation of a lead to the external pump electrode is shifted away from the external pump electrode toward the terminal contacts of the lead. The insulation is shifted between 100 μm and 2000 μm, e.g., 350 μm, toward the terminal contacts. This makes it possible to achieve an additional degree of freedom in the design of the sensor element and thus to achieve an optimum between undesirable occurrence of signal overshoot (lambda=1 ripple) and the response to dynamic pressure changes.

### BRIEF DESCRIPTION OF THE DRAWINGS

FIG. 1 shows a longitudinal cross-sectional view of a sensor element according to a first exemplary embodiment of the present invention.

FIG. 2 shows a top view of the major surface area of the sensor element shown in FIG. 1.

FIG. 3 shows a top view of the major surface area of an alternative example embodiment of the sensor element according to the present invention.

FIG. 4 shows a longitudinal cross-sectional view through a sensor element according to another exemplary embodiment of the sensor element according to the present invention.

FIG. 5 shows a top view of the sensor element shown in FIG. 4.

FIG. 6 shows a longitudinal cross-sectional view of a sensor element according to yet another exemplary embodiment of the present invention.

### DETAILED DESCRIPTION

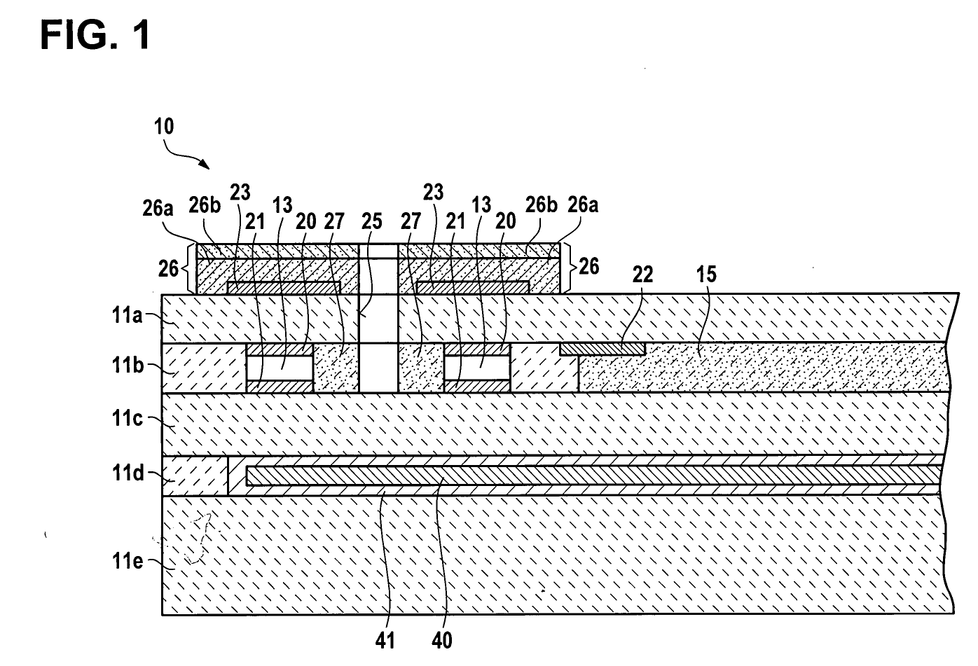

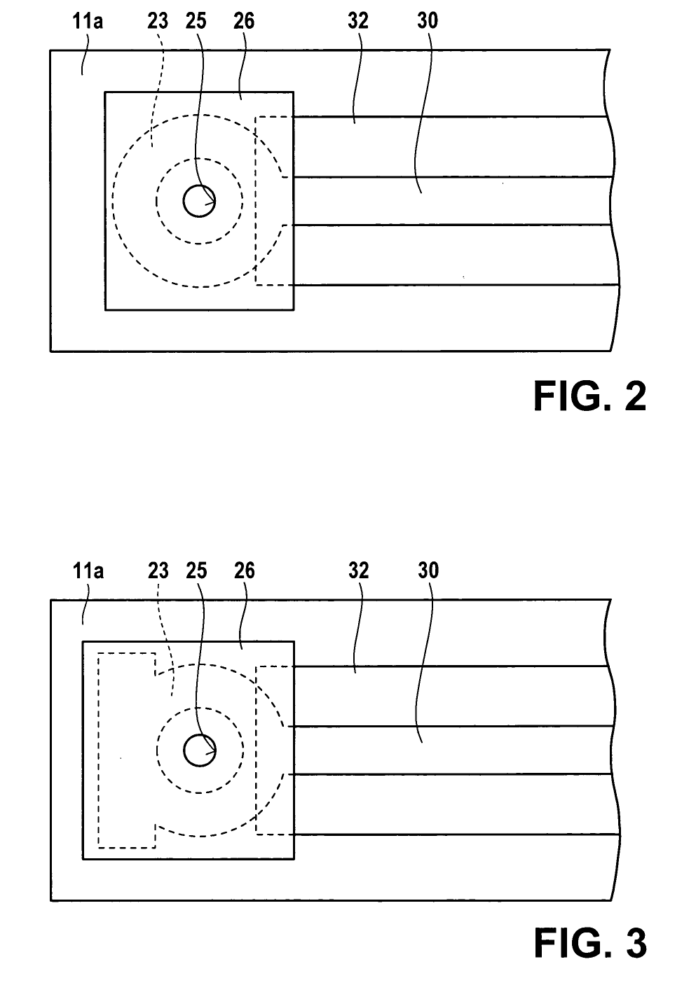

FIGS. 1 and 2 show a schematic structure of a first embodiment of the present invention. Planar sensor element 10 of an electrochemical gas sensor has a plurality of oxygen-conducting solid electrolyte layers 11a, 11b, 11c, 11d, and 11e, for example. Solid electrolyte layers 11a, 11c, and 11e are designed as ceramic sheets and form a planar ceramic body. They are composed of an oxygen-conducting solid electrolyte material such as stabilized Y₂O₂ or partially stabilized ZrO₂.

In contrast, solid electrolyte layers 11b and 11d are produced by screen printing on a paste-like ceramic material, for example, on solid electrolyte layer 11a. As an example, the same solid electrolyte material as used for solid electrolytes 11a, 11c, and 11d is used as the ceramic component of the paste-like material.

The integrated form of the planar ceramic body of sensor element 10 is manufactured by laminating together the ceramic sheets imprinted with solid electrolyte layers 11b, 11d and function layers and subsequently sintering the laminated structure.

Sensor element 10 includes an internal gas space in the form of measuring gas space 13. It has an annular design and is connected to the gas mixture atmosphere via an opening 25. Opening 25 is produced in solid electrolyte 11a perpendicularly to the surface of sensor element 10.

An external pump electrode 23 covered with a porous protective layer 26 is applied, e.g., in an annular shape around opening 25, on solid electrolyte layer 11a, on the major surface area of sensor element 10 directly facing the gas mixture. On the side of solid electrolyte 11a facing measuring gas space 13, there is a corresponding internal pump electrode 20, which also has an annular design, matching the annular geometry of measuring gas space 13. The two pump electrodes 20, 23 together form an electrochemical pump cell.

A measuring electrode 21 is located in measuring gas space 13 opposite internal pump electrode 20. It also has an annular design, for example. A corresponding reference electrode 22 is situated in a reference gas channel 15. It is integrated into the same solid electrolyte layer 11b as measuring gas space 13 and is filled, for example, by a porous ceramic material. Alternatively, reference gas channel 15 may also be designed to have a cavity in contact with a reference gas atmosphere. Measuring electrode 21 and reference electrode 22 together form a Nernst cell, i.e., a concentration cell.

Inside measuring gas space 13, there is a porous diffusion barrier 27 upstream from internal pump electrode 20 and measuring electrode 21 in the direction of diffusion of the gas mixture. Porous diffusion barrier 27 forms a diffusion resistance with respect to the gas mixture diffusing to electrodes 20, 21. In the case of a reference gas channel 15 filled with a porous ceramic material, diffusion barrier 27 and the filling of reference channel 15 are made of the same material, for example, to make streamlined manufacture in a single process step possible.

External pump electrode 23 is contacted by a printed conductor 30, shown in FIG. 2, which is applied to the surface of solid electrolyte layer 11a. An insulation layer 32 made of aluminum oxide, for example, electrically insulates solid electrolyte layer 11a from printed conductor 30. Measuring electrode 21 and reference electrode 22 are also contacted via printed conductors (which are not shown for the sake of clarity), the printed conductors running between solid electrolyte layers 11b and 11c and being connected to the major surface area of the sensor element via bushings (not shown).

To ensure that thermodynamic equilibrium of the gas mixture components is established at the electrodes of the sensor element, all used electrodes are made of a catalytically active material, for example, platinum, the electrode material of all electrodes being used as cermet to be sintered with the ceramic sheets.

Furthermore, a resistance heater 40 is integrated into solid electrolyte layer 11d and embedded into an electrical insulation 41 of Al₂O₃, for example. Sensor element 10 is heated to an appropriate operating temperature of 750° C., for example, by resistance heater 40.

Internal pump electrode 20 and external pump electrode 23 together form a pump cell. It effects oxygen transport from and into measuring gas space 13. Measuring electrode 21 and reference electrode 22 are connected to form a concentration cell. It allows the oxygen potential of measuring electrode 21, which is a function of the oxygen concentration in measuring gas space 13, to be compared directly to the constant oxygen potential of reference electrode 22 in the form of a measurable electrical voltage. The pump voltage to be applied to the pump cell is selected such that a constant voltage of 450 mV, for example, is established across the concentration cell. The pump current flowing between the electrodes of the pump cell is used as a measuring signal proportional to the oxygen concentration in the exhaust gas.

As mentioned previously, the electrochemical pump cell is controlled in such a way that, at lambda values <1 in the gas mixture, oxygen is transported from the external to the internal pump electrode, and at lambda values >1, oxygen is transported from the internal to the external pump electrode. Thus, at lambda=1, the polarities of pump electrodes 20, 23 reverse with the undesirable effect of a counter-swing or overshoot phenomenon of the measuring signal, which is known as lambda=1 ripple.

Protective layer 26 is to be provided with a higher diffusion resistance, while enlarging the surface area of external pump electrode 23. This is accomplished in that the requirement of a higher pump voltage to be applied to the pump cell resulting from the larger diffusion resistance of protective layer 26 is essentially eliminated by an appropriate enlargement of the surface area of external pump electrode 23, and if a predefined pump voltage is applied, essentially the same pump current is established as in a sensor element in which the internal and external pump electrodes have comparable dimensions and the external pump electrode is coated with an ordinary porous ceramic protective layer.

While the surface area of internal pump electrode 20 is 2.7 mm², for example, a surface area of 6 mm² to 10 mm², for example, is provided for external pump electrode 23. The ratio of the surface area of external pump electrode 23 to that of internal pump electrode 20 may be 3 to 6, e.g., 2 to 5. The pump current established between pump electrodes 20, 23 is 180 μA, for example, at an oxygen partial pressure of 0.5 hPa.

To increase the diffusion resistance of protective layer 26, either its porosity may be reduced or its layer thickness may be increased. In the exemplary embodiment depicted in FIG. 1, protective layer 26 is designed as a double layer, a porous portion 26a and a less porous portion 26b being provided. Protective layer 26 is designed such that external pump electrode 23 is essentially covered. Protective layer 16 may have a through-hole in the area of opening 25, but is not essential.

FIG. 3 shows a variant of the exemplary embodiment illustrated in FIGS. 1 and 2. The same reference symbols in FIG. 3 denote the same components as shown in FIGS. 1 and 2. External pump electrode 23 shown in FIG. 3 is distinguished by an area center of gravity, which is oriented toward the measuring gas-side end of sensor element 10. The background of this design is that the greatest possible distance is achieved between the area center of gravity of external pump electrode 23 and the area center of gravity of reference electrode 22.

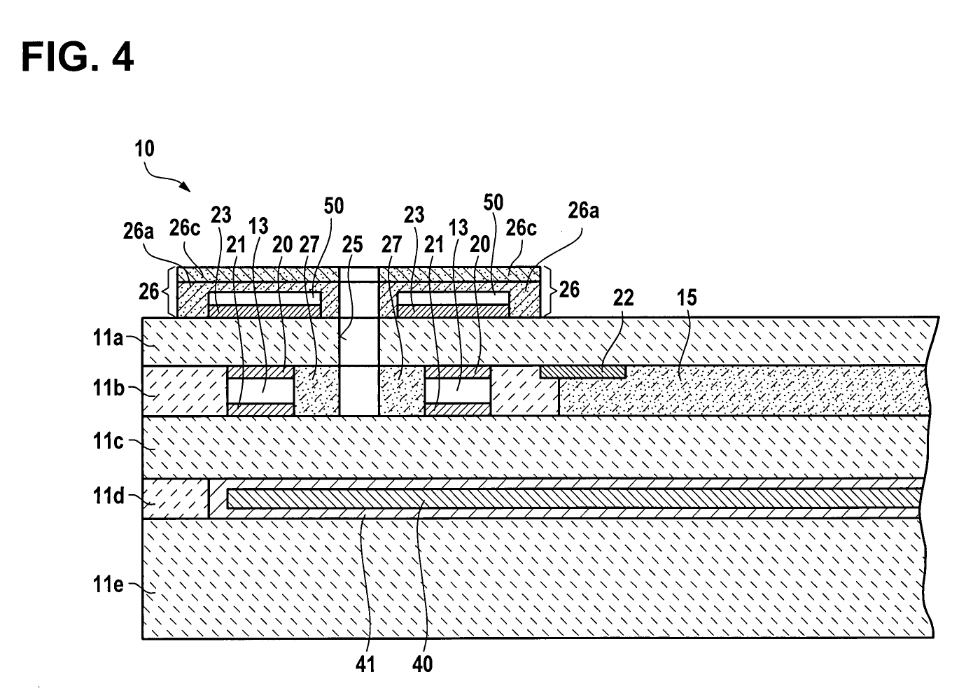

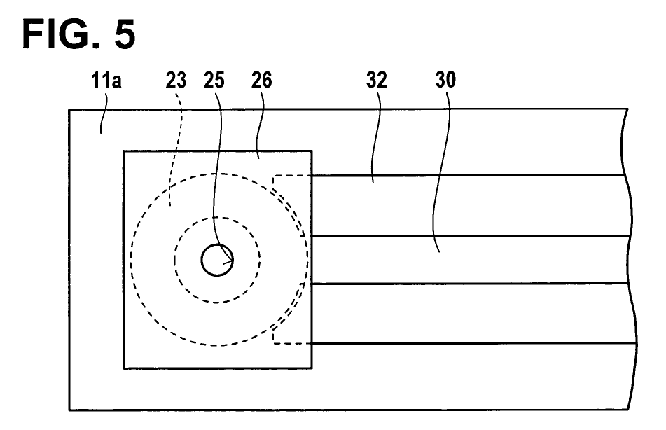

A sensor element 10 according to a second exemplary embodiment of the present invention is described below with reference to FIGS. 4 and 5. The same parts or parts having the same function are labeled with the same reference numerals as in the first exemplary embodiment shown in FIGS. 1 and 2.

Unlike the first exemplary embodiment, sensor element 10 according to the second exemplary embodiment additionally includes a cavity 50 over external pump electrode 23. Cavity 50 has an annular design and is formed over the entire outward-directed surface of external pump electrode 23. A thickness of cavity 50 is between 5 μm and 50 μm, e.g., 15 μm.

As is apparent from FIG. 4, the cavity is formed in the area of protective layer 26, more precisely in area 26a. In this exemplary embodiment, protective layer 26 is provided with a gas-tight cover layer 26c, which allows only lateral gas access to external pump electrode 23. Gas-tight layer 26c may be made of ZrO₂ or Al₂O₃.

The surface of the external pump electrode is significantly larger compared to internal pump electrode 20 and is 10 mm², for example. Protective layer 26 is designed such that at a partial pressure of 0.5 mbar a maximum current drops to less than 45 μA, e.g., to 20 μA.

As FIG. 5 further shows, a lead insulation 32 may be shifted toward the terminal contacts of printed conductor 30. The lead insulation has an arc-shaped recessed area 32a. This reinforces the connection of the external pump electrode to the concentration cell, so that the response of the pump cell to pressure fluctuations is dampened.

Thanks to the advantageous combination of enlarged external pump electrode 23 and cavity 50, shown in the second exemplary embodiment, the sensor element may be optimized between lambda=1 ripple and sensor element response to dynamic pressure changes. In the related art, in contrast, a small surface of the external electrode and the lead insulation shifted to the measuring gas side result in an intense response of the sensor element to dynamic pressure changes. Cavity 50 over external pump electrode 23 slows down the propagation of gas exchanges. The dynamics of the sensor element may thus become lambda-independent, which makes even more accurate measurements possible.

Other than the above-noted differences, the sensor element of the second exemplary embodiment is identical to that of the first exemplary embodiment, so that reference may be made to the description given in connection with the first exemplary embodiment.

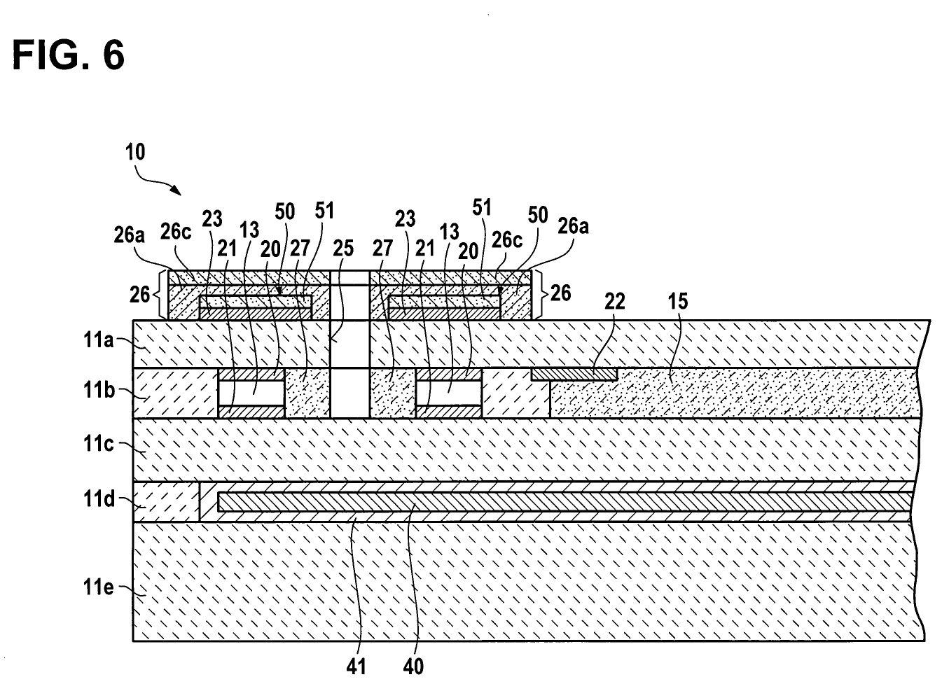

FIG. 6 shows a sensor element 10 according to a third exemplary embodiment of the present invention, the same parts or parts having the same function being provided with the same reference symbols as in the preceding exemplary embodiments shown in FIGS. 1-5.

Unlike the second exemplary embodiment, according to the third exemplary embodiment, a cavity 50 over external pump electrode 23 of sensor element 10 is filled with a porous material 51. Porous material 51 has a higher porosity than a porosity of protective layer 26. Thanks to the selection of the porosity of porous material 51 in cavity 50 over external pump electrode 21, an additional degree of freedom is obtained regarding the design of sensor element 10. Otherwise this exemplary embodiment is identical to the second exemplary embodiment, so that reference may be made to the description given in connection with the second exemplary embodiment.

The sensor element according to the present invention and the method for its manufacture are not limited to the specific embodiments shown, i.e., other embodiments including other measuring electrodes, solid electrolytic layers, etc., are also conceivable. Furthermore, the above-described design of the external pump electrode and its protective layer may also be used in sensor elements which are used for determining other gases, such as nitrogen oxide, sulfur oxide, ammonia, or hydrocarbons.

What is claimed is:

1. A sensor element for determining an oxygen concentration in an exhaust-gas mixture of an internal combustion engine, comprising:
at least one pump cell which includes a first electrode and a second electrode, the first electrode being situated in a measuring gas space of the sensor element, wherein the pump cell pumps oxygen one of into and out of the measuring gas space of the sensor element, and wherein a surface area of the second electrode exposed to the exhaust-gas mixture is greater than a surface area of the first electrode exposed to the exhaust-gas mixture; and
a diffusion barrier for the second electrode, wherein the diffusion barrier acts against the exhaust-gas mixture diffusing to the second electrode, a diffusion resistance of the diffusion barrier being determined by at least one of porosity and layer thickness of the diffusion barrier, and wherein the diffusion resistance of the diffusion barrier is selected such that, for a predefined pump voltage applied to the first electrode and the second electrode, a resulting pump current flowing between the first electrode and the second electrode is substantially the same as a hypothetical pump current flowing between the first electrode and the second electrode in the case where the diffusion barrier for the second electrode is not provided and the first electrode and the second electrode have the same surface areas exposed to the exhaust-gas mixture.

2. The sensor element as recited in claim 1, wherein the resulting pump current flowing between the first electrode and the second electrode is between 150 μA and 220 μA for an oxygen partial pressure of 0.5 hPa.

3. The sensor element as recited in claims 1, wherein the surface area of the second electrode exposed to the exhaust-gas mixture is 1.5 to 6 times greater than the surface area of the first electrode exposed to the exhaust-gas mixture.

4. The sensor element as recited in claim 1, wherein the surface area of the second electrode exposed to the exhaust-gas mixture is 3 to 5 times greater than the surface area of the first electrode exposed to the exhaust-gas mixture.

5. The sensor element as recited in claim 1, wherein the sensor element has a measuring gas-side end and a support-side end, and the surface area of the second electrode exposed to the exhaust-gas mixture increases in the direction of the measuring gas-side end of the sensor element.

6. The sensor element as recited in claim 1, wherein the diffusion barrier is a porous ceramic layer.

7. The sensor element as recited in claim 1, wherein the diffusion barrier is made of zirconium dioxide.

8. The sensor element as recited in claim 1, wherein the major surface area of the second electrode exposed to the exhaust-gas mixture has a surface area of 6 mm² to 10 mm².

9. The sensor element as recited in claim 1, wherein a cavity is provided adjacent to a side of the second electrode facing away from the first electrode.

10. The sensor element as recited in claim 9, wherein the cavity is filled with a porous material having a higher porosity than the porosity of the diffusion barrier.

11. The sensor element as recited in claim 9, wherein the cavity is formed over the entire surface of the second electrode.

12. The sensor element as recited in claim 9, wherein the cavity has a thickness between 5 μm and 50 μm.

13. The sensor element as recited in claim 9, wherein the diffusion barrier has a thickness such that, at an oxygen partial pressure of 0.5 mbar, a maximum current of between 20 μA and 45 μA flows between the first electrode and the second electrode.

14. The sensor element as recited in claim 13, wherein the diffusion barrier includes a gas-tight layer.

15. The sensor element as recited in claim 9, further comprising;
a printed conductor contacting the second electrode; and
an insulating layer for the printed conductor, wherein the insulating layer is shifted toward terminal contacts of the printed conductor.

16. The sensor element as recited in claim 15, wherein the insulating layer is shifted toward the terminal contacts by 100 μm to 2000 μm.

17. A method for manufacturing a sensor element for determining an oxygen concentration in an exhaust-gas mixture of an internal combustion engine, the method comprising:
providing at least one pump cell which includes a first electrode and a second electrode, the first electrode being situated in a measuring gas space of the sensor element, wherein the pump cell is configured to pump oxygen one of into and out of the measuring gas space of the sensor element, and wherein a surface area of the second electrode exposed to the exhaust-gas mixture is selected to be greater than a surface area of the first electrode exposed to the exhaust-gas mixture; and
providing a diffusion barrier for the second electrode, wherein the diffusion barrier acts against the exhaust-gas mixture diffusing to the second electrode, a diffusion resistance of the diffusion barrier being determined by at least one of porosity and layer thickness of the diffusion barrier, and wherein the diffusion resistance of the diffusion barrier is selected such that, for a predefined pump voltage applied to the first electrode and the second electrode, a resulting pump current flowing between the first electrode and the second electrode is substantially the same as a hypothetical pump current flowing between the first electrode and the second electrode in the case where the diffusion barrier for the second electrode is not provided and the first electrode and the second electrode have the same surface areas exposed to the exhaust-gas mixture.
